(19) United States
(12) Patent Application Publication
(10) Pub. No.: US 2010/0201526 A1
(43) Pub. Date: Aug. 12, 2010

(54) Pregnancy Belt

(76) Inventor: Marjan Hafezi, Redwood City, CA (US)

Correspondence Address: GLENN PATENT GROUP, 3475 EDISON WAY, SUITE L, MENLO PARK, CA, 94025, US

(21) Appl. No.: 12/367,334

(22) Filed: Feb. 6, 2009

(51) Int. Cl. G08B 23/00

(52) U.S. Cl. 340/573.7

(57) ABSTRACT

An apparatus ensuring that an expecting mother does not lie on her back by alerting an expecting mother upon such an event. An adjustable and flexible belt is provided which includes one or more sensors positioned at or near the center of the belt to determine when an expecting woman wearing the belt is sleeping on her back and an alarm that is activated by the sensor to alert a sleeping mother when she is lying on her back.

### BACKGROUND OF THE INVENTION

1. Technical Field

The invention relates generally to the field of pregnancy devices. More specifically, the invention relates to a wearable apparatus to alert an expecting mother of an unsafe sleeping position.

2. Description of the Related Art

During the term of a pregnancy, especially in the second and third trimester, the blood flow and oxygenation to the fetus is crucial to its health. The circulatory system of the mother and fetus allow the best oxygenation and blood flow when the mother lies on her left side. This flow may be compromised when the mother lies on her back and especially for a long period of time. Therefore, there is a need for an apparatus to ensure that an expecting mother does not lie on her back and an apparatus to alert a mother upon such an event.

### SUMMARY OF THE INVENTION

An embodiment of the invention comprises an apparatus that ensures that an expecting mother does not lie on her back by alerting a mother upon such an event. In some embodiments of the invention, an adjustable and flexible belt is provided which includes one or more sensors positioned at or near the center of the belt to determine when an expecting mother wearing the belt is sleeping on her back and an alarm to alert a sleeping expecting mother when she is lying on her back.

In some embodiments of the invention, the alarm comprises a vibration apparatus that gently vibrates to alert an expecting mother wearing the belt when she is sleeping on her back. In some other embodiments, the alarm comprises an auditory alarm. In yet other embodiments, the alarm comprises both an auditory alarm and a vibration apparatus. Preferably, the relative strength of the auditory alarm and/or the vibration is adjustable.

In some embodiments, an adjustable and flexible belt is configured with an integral sensor having a means for wireless transmission of data and an external alarm that is capable of receiving wireless data. According to these embodiments, the sensor sends a signal to the alarm upon sensing that an expecting mother wearing the belt is sleeping on her back. Upon receipt of the signal the alarm alerts the mother of her unsafe position.

In alternative embodiments of the invention, the sensor is positioned off center of the belt to alert an expecting woman when she is not sleeping on her side.

### BRIEF DESCRIPTION OF THE DRAWINGS

FIG. 1A is a schematic isometric view of a pregnancy belt with an integral sensor and alarm according to the invention;

FIG. 1B is a schematic isometric view of a pregnancy belt with a removable sensor/alarm module according to the invention;

FIG. 2A is a schematic isometric view of a pregnancy belt with an integral sensor and external alarm according to some embodiments of the invention;

FIG. 2B is a schematic isometric view of a pregnancy belt with an integral sensor in radio communication with a clock radio alarm according to some embodiments of the invention; and

FIG. 3 is a schematic isometric view of a pregnancy belt with an integral side sleeping sensor and an external alarm according to some alternative embodiments of the invention.

### DETAILED DESCRIPTION OF THE INVENTION

The following disclosure teaches an apparatus configured to ensure that an expecting mother does not lie on her back wherein the apparatus is configured to alert a mother upon such an event. In the present preferred embodiment of the invention, an adjustable and flexible belt is provided which includes one or more pressure or position sensors integrated therein, that activate the alarm to alert a sleeping mother when she is lying on her back.

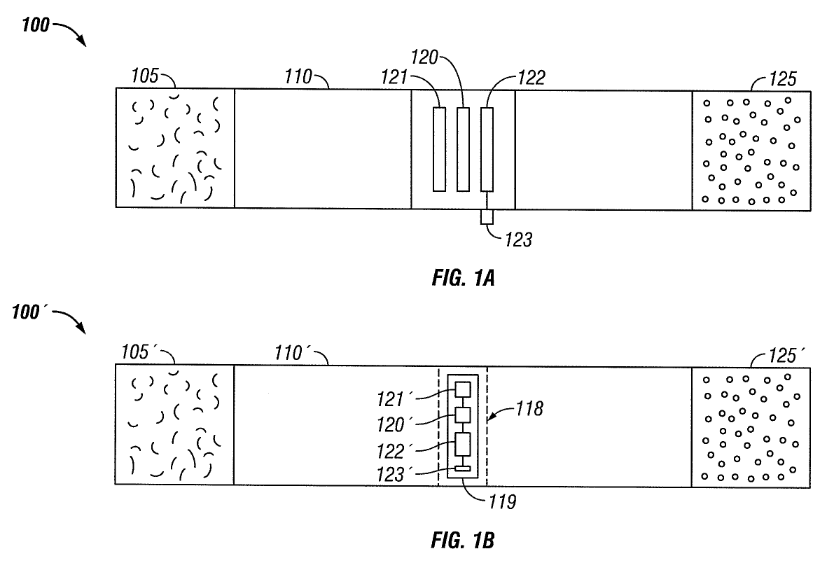

FIG. 1A is a schematic isometric view of a pregnancy belt 100 according to the invention. The pregnancy belt 100 comprises a substantially axial body member 110, two corresponding securing means 105, 125, a sensor 120, an alarm 121, and a power source 122, such as a battery. Additionally, a switch 123 is coupled with the power source 122 for turning the sensor 120 and alarm 121 on and off. In the presently preferred embodiment, the sensor 120 is a pressure sensor and is disposed substantially in the center of the belt 101 between the securing means 105, 125. According to these embodiments, the sensor 120 is configured to be worn on or near an expecting woman's back so as to sense when an expecting mother is lying on her back. In this event, the sensor 120 is configured to alert the expecting mother of her unsafe position.

Additionally, positional sensors, mercury sensors, and the like may be used as well. In fact, it will be apparent to those with ordinary skill in the art having the benefit of this disclosure that any sensor can be used to practice the invention as long as the sensor is capable of actuating an alarm upon the pregnant woman lying in a particular position.

The belt 100 should be comfortable when an expecting mother wears it about her waist or torso. It is also important that the belt 100 be flexible to allow for the woman's body to grow as she comes to term. Therefore, the body member 110 is preferably comprised of a soft yet resilient material, such as an elastic or similar material.

Similarly, the securing means 105, 125 are configured to be adjustable such that one belt 101 may be used throughout a pregnancy. In the presently preferred embodiment of the invention, the securing means 105, 125 comprise corresponding sides of hook and loop fasteners, such as Velcro. However, it will be readily apparent to those with ordinary skill in the art having the benefit of this disclosure that a wide variety of securing means may be chosen to accomplish the same or similar design goals.

In some embodiments of the invention, and as shown in FIG. 1, the sensor 120, the alarm, 121 and the power source 122 are integral to the belt 101 and are hardwired into the belt 101. In some embodiments the sensor 120, the alarm 121 and the power source 122 are individually disposed within the pregnancy belt 100 and coupled with wires.

In some embodiments, the sensor 120, the alarm 121, and the power source 122 are integrated within a unitary module that fits within a pouch or sleeve formed within the belt. FIG. 1B is a schematic isometric view of a pregnancy belt 100′ according to the invention. The pregnancy belt 100′ comprises a substantially axial body member 110′, two corresponding securing means 105′, 125′, and a unitary module 119. The unitary module 119 comprises a sensor 120′, an alarm 121′, and a power source 122′. Additionally, a switch 123′ is coupled with the power source 122′ for turning the sensor 120′ and alarm 121′ on and off. The unitary module 119 is inserted with a pouch 118 located within the pregnancy belt 100′. According to these embodiments, the unitary module 199 is removable, such that the pregnancy belt 100′ may be easily laundered.

In some embodiments of the invention, the alarm comprises a vibrating apparatus that gently vibrates to alert the mother that she is lying on her back. In some other embodiments, the alarm comprises an audio signal that is broadcast to wake the mother. In yet other embodiments, the alarm comprises both an auditory alarm and a vibrating apparatus. The sound level and/or vibration level is preferably adjustable to accommodate varying levels of sleep and differing amounts of sensation needed to wake a sleeping person.

Furthermore, in some other embodiments, the sensor and the alarm are separately disposed. According to these embodiments, it is preferable that the sensor is integrally disposed in the belt while the alarm is separately located and is in wireless communication with the sensor.

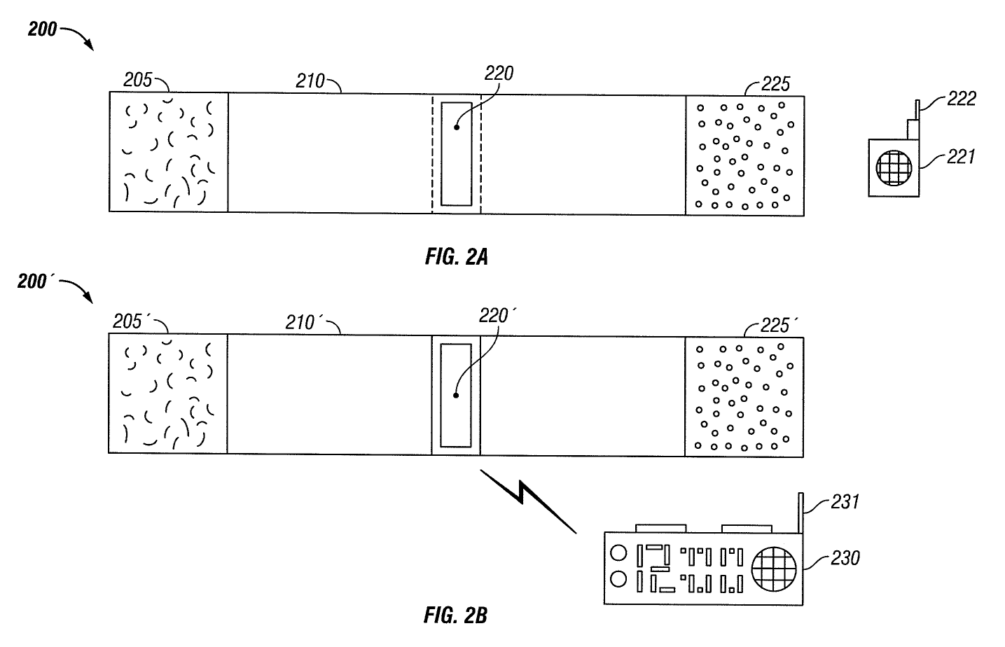

FIG. 2A illustrates a schematic isometric view of a pregnancy belt 200 comprising a body member 210 with a sensor 220 and external alarm 221 according to alternative embodiments of the invention. The belt 200 further comprises securing means 205 and 225. According to FIG. 2, the sensor 220 is removably coupled with the body member 210. Furthermore, the sensor 220 is communicatively coupled with an external alarm 221, which can be positioned at convenient locations, i.e. near an expecting mother's head and ears. In some embodiments of the invention, the sensor 220 and the alarm 221 communicate using an RF signal or other wireless signal. In some other embodiments, the sensor 220 and the alarm 221 communicate via an IEEE 802.11 protocol signal or a Bluetooth® signal.

According to the radio communication embodiments, the sensor 220 comprises a radio transmitter and the alarm 221 comprises a radio receiver 222. In use, when an expecting mother sets off the sensor 220 by laying on her back the sensor 220 sends a signal to the receiver 222, which sets off the alarm 221 to wake the expecting mother.

In yet other embodiments of the invention, the pregnancy belt is configured to operate with a sensor and an already existing alarm via a radio signal. FIG. 2B is a schematic isometric view of a pregnancy belt 200′ in communication with a clock radio 230 according to some embodiments of the invention. The pregnancy belt 200′ comprises a substantially axial body member 210′, two corresponding securing means 205′, 225′, and a unitary module 220′ comprising a sensor, a power source, and a switch. The unitary module 220′ further comprises an RF transmitter for emitting a radio frequency upon actuation of the sensor. In some embodiments, the frequency of the signal is constant. In some other embodiments, the frequency of the signal is adjustable.

The clock radio 230 includes an antenna 231 for receiving radio signals. The clock radio 230 is set to broadcast an alarm upon sensing the operating frequency emitted from the pregnancy belt 200′.

In operation, the unitary module 220′ emits a unique radio frequency when actuated by an expecting mother lying on the sensor. Accordingly, the clock radio 230 broadcasts an alarm upon sensing the operating frequency, thus alerting the expecting mother.

As explained above, the circulatory system of the mother and fetus allow the best oxygenation and blood flow when the mother lies on her side. Therefore, in some other embodiments of the invention, a pregnancy belt is configured to alert an expecting mother when she is not sleeping on her side.

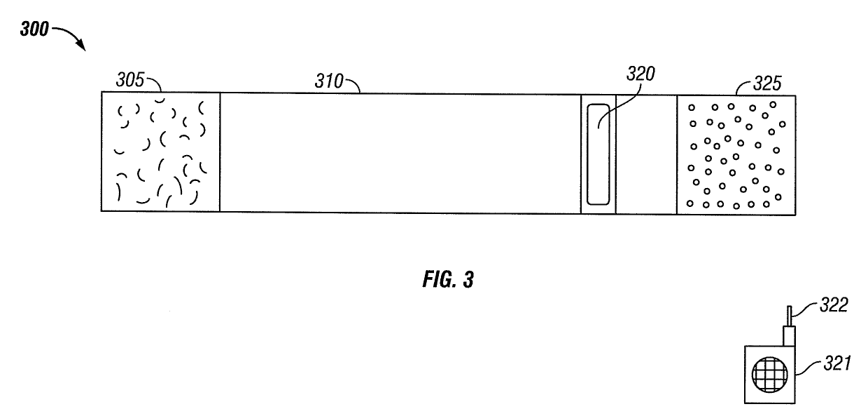

FIG. 3 illustrates a schematic isometric view of an alternative pregnancy belt 300 comprising a body member 310 with a side sleeping sensor 320. The apparatus also comprises a wireless alarm 321 with a receiver 322 and two corresponding securing means 305, 315. As shown, the sensor 320 is disposed off-center on the belt 301 such that it is positioned under an expecting mother's side while sleeping.

In some other embodiments of the invention, the position of the sensor is adjustable and toggles between alerting the woman when she is laying on it and alerting a woman when she is not laying on it. According to these embodiments, the belt and sensor are able to either alert a woman who is sleeping on her back or not sleeping on her side.

As will be understood by those familiar with the art, the invention may be embodied in other specific forms without departing from the spirit or essential characteristics thereof. Likewise, the particular naming and division of the members, features, attributes, and other aspects are not mandatory or significant, and the mechanisms that implement the invention or its features may have different names, divisions and/or formats. Accordingly, the disclosure of the invention is intended to be illustrative, but not limiting, of the scope of the invention, which is set forth in the following Claims.

1. An alarm belt comprising:
a belt member having an elongated axis of sufficient length and adjustable to completely encircle the girth of a pregnant woman during the entire term of her pregnancy;
an attaching means for securing the belt about said pregnant woman;
a sensor associated with the belt for sensing when the pregnant woman is lying in a particular position; and
an alarm coupled to said sensor for alerting said pregnant woman when said sensor senses that said pregnant woman is lying in a particular position.

2. The alarm belt of claim 1, said belt comprising a soft and resilient material.

3. The alarm belt of claim 1, wherein the attaching means is adjustable.

4. The alarm belt of claim 1, said attaching means comprising:
a first attaching means;
a second attaching means,
wherein the first attaching means is substantially disposed on a first terminal end of the belt and the second attaching means is substantially disposed on a second terminal end of the belt; and
wherein said first and second attaching means are removably joinable to the other.

5. The alarm belt of claim 4, the first attaching means comprising a portion of fabric containing hook members of a hook and loop fastener, and
the second attaching means comprising a portion of fabric containing loop members of a hook and loop fastener.

6. The alarm belt of claim 1, wherein the sensor is integrated within the belt.

7. The alarm belt of claim 1, further comprising a power source coupled with the sensor for providing power to the sensor.

8. The alarm belt of claim 7, further comprising a switch coupled with the power source for turning the sensor on and off.

9. The alarm belt of claim 1, wherein the sensor, the alarm and the power source are integrated with a unitary module, and wherein the unitary module is removably coupled with the belt.

10. The alarm belt of claim 9, the belt further comprising a pocket for accepting the unitary module.

11. The alarm belt of claim 1, wherein the sensor is disposed within the belt, and wherein the alarm is remotely located and in wireless communication with the sensor.

12. The alarm belt of claim 11, the sensor further comprising:
means for sending data wirelessly to the alarm;
the alarm further comprising means for receiving wireless data from the sensor for converting the wireless data into an alarm signal, when said pregnant woman lays upon sensor.

13. The alarm belt of claim 10, said signal comprising any of an RF signal, an IEEE 802.11 protocol signal, and a Bluetooth® signal.

14. The alarm belt of claim 1, wherein the sensor is disposed substantially in the center of the belt and positioned beneath a wearer's back when the belt is worn; and
wherein the sensor senses when the pregnant woman is lying on her back and actuates the alarm to alert the pregnant woman that she is lying on her back.

15. The alarm belt of claim 1, wherein the sensor is disposed off-center of the belt and positioned beneath a pregnant woman's side when the belt is worn; and
wherein the sensor senses when the pregnant woman is not lying on her side and actuates the alarm to alert the that she is not laying on her side.

16. The alarm belt of claim 1, the alarm comprising an auditory alarm.

17. The alarm belt of claim 1, the alarm comprising a vibration apparatus.

18. The alarm belt of claim 1, wherein the alarm further comprising means for adjusting a level of the alarm.

19. A pregnancy belt, comprising:
a belt member having an elongated axis having a first terminal end and second terminal end, said belt comprising a soft and resilient material;
an attaching means for securing the belt to a pregnant woman, the attaching means comprising a first attaching member associated with the first terminal end of the belt and a second attaching member associated with the second terminal end of the belt, the first attaching member and the second attaching member providing an adjustable attachment of the belt around the pregnant woman;
a sensor associated with the belt for sensing when the pregnant woman is lying on her back; and
an alarm activated by said sensor to alert the pregnant woman when she is lying on her back.

20. The pregnancy belt of claim 19, wherein the sensor is removably associated with the belt.

21. The pregnancy belt of claim 19, wherein the sensor is integrated with the belt.

22. The pregnancy belt of claim 19, wherein the sensor is associated with the belt, and wherein the alarm is remotely located from the belt and in wireless communication with the sensor.

23. The pregnancy belt of claim 19, the sensor further comprising:
a means for sending data wirelessly to the alarm;
the alarm further comprising means for receiving said wireless data from the sensor and producing an alarm signal in response thereto.

24. The pregnancy belt of claim 23, the wireless signal comprising any of an RF signal, an IEEE 802.11 protocol signal, and a Bluetooth® signal.

25. The pregnancy belt of claim 19, the alarm comprising an auditory alarm.

26. The pregnancy belt of claim 19, the alarm comprising a vibration alarm.

27. The pregnancy belt of claim 19, further comprising:
a means for adjusting a level of the alarm.

28. An alarm belt system comprising:
an alarm belt comprising:
a belt member having an elongated axis of sufficient length and adjustable to completely encircle the girth of a pregnant woman during the entire term of her pregnancy;
an attaching means for securing the belt about said pregnant woman;
a sensor associated with the belt for sensing when the pregnant woman is lying in a particular position;
a power source coupled with said sensor; and
a transmitter for sending a signal upon actuation of the sensor; and
an alarm module with an antenna for receiving said signal, wherein the alarm module sounds an alarm upon receipt of said signal for alerting said pregnant woman that said pregnant woman is lying in said particular position.

29. The alarm belt of claim 28, said belt comprising a soft and resilient material.

30. The alarm belt of claim 28, wherein the attaching means is adjustable.

31. The alarm belt of claim 28, said attaching means comprising:
a first attaching means;
a second attaching means,
wherein the first attaching means is substantially disposed on a first terminal end of the belt and the second attaching means is substantially disposed on a second terminal end of the belt; and
wherein said first and second attaching means are removably joinable to the other.

32. The alarm belt of claim 31, the first attaching means comprising a portion of fabric containing hook members of a hook and loop fastener, and
the second attaching means comprising a portion of fabric containing loop members of a hook and loop fastener.

33. The alarm belt of claim 28, further comprising a switch coupled with the power source for turning the sensor on and off.

34. The alarm belt of claim 28, wherein the sensor, the power source, and the transmitter are integrated with a unitary module, and wherein the unitary module is removably coupled with the belt.

35. The alarm belt of claim 34, the belt further comprising a pocket for accepting the unitary module.

36. The alarm belt of claim 28, wherein said alarm comprises an auditory alarm.

37. The alarm belt of claim 28, wherein said alarm comprises a vibration apparatus.

38. The alarm belt of claim 28, wherein the alarm module further comprises a means for adjusting a level of the alarm.
